(19) United States
(12) Patent Application Publication
(10) Pub. No.: US 2010/0313239 A1
(43) Pub. Date: Dec. 9, 2010

(54) AUTOMATED ACCESS CONTROL FOR RENDERED OUTPUT

(75) Inventors: Al Chakra, Apex, NC (US); Simon P. O'Doherty, Ard-Na-Griene (IE); John Rice, Tramore (IE); Beng K. Yap, Santry (IE)

Correspondence Address: LEE LAW, PLLC;IBM CUSTOMER NUMBER, P.O. BOX 189, PITTSBORO, NC, 27312, US

(73) Assignee: INTERNATIONAL BUSINESS MACHINES CORPORATION, Armonk, NY (US)

(21) Appl. No.: 12/481,011

(22) Filed: Jun. 9, 2009

(51) Int. Cl. G06F 21/00; G06F 12/14; G06F 17/30; G06F 3/00

(52) U.S. Cl. 726/2; 711/163; 340/686.6; 715/741; 711/E12.091

(57) ABSTRACT

A content rendering action is detected at a content access control module associated with renderable content stored within a memory associated with the content access control module. A portion of the renderable content is determined to be controlled by an access privilege requirement higher than an access privilege level of a person, a device, or a location associated with the detected content rendering action. The portion of the renderable content determined to have the access privilege requirement higher than the access privilege level of the person, the device, or the location associated with the detected content rendering action is automatically redacted.

### BACKGROUND

The present invention relates to information access control. More particularly, the present invention relates to automated access control for rendered output.

Users of electronic computing devices use the devices for a variety of communication activities. Example communication activities include email, instant messaging, meeting presentations, video conferencing, web conference, remote login for technical support of applications, and many other types of communication activities. Display and printer devices associated with these computing devices render output for these and other communication activities. Participants associated with the respective communication activities view the rendered output on the associated display devices and paper including the rendered output, respectively.

### BRIEF SUMMARY

A method includes detecting, at a content access control module, a content rendering action associated with renderable content stored within a memory associated with the content access control module; determining that at least one portion of the renderable content is controlled by an access privilege requirement higher than an access privilege level of at least one of a person, a device, and a location associated with the detected content rendering action; and automatically redacting the at least one portion of the renderable content determined to have the access privilege requirement higher than the access privilege level of the at least one of the person, the device, and the location associated with the detected content rendering action.

An apparatus includes a memory that stores renderable content; and a content access control module, configured to: detect a content rendering action associated with the renderable content stored in the memory; retrieve the renderable content from the memory; determine that at least one portion of the renderable content is controlled by an access privilege requirement higher than an access privilege level of at least one of a person, a device, and a location associated with the detected content rendering action; and automatically redact the at least one portion of the renderable content determined to have the access privilege requirement higher than the access privilege level of the at least one of the person, the device, and the location associated with the detected content rendering action.

A computer program product includes a computer readable storage medium having computer readable program code embodied therewith, the computer readable program code including: computer readable program code configured to detect a content rendering action associated with the renderable content; computer readable program code configured to determine that at least one portion of the renderable content is controlled by an access privilege requirement higher than an access privilege level of at least one of a person, a device, and a location associated with the content rendering action; and computer readable program code configured to automatically redact the at least one portion of the renderable content determined to have the access privilege requirement higher than the access privilege level of the at least one of the person, the device, and the location associated with the content rendering action

### BRIEF DESCRIPTION OF THE SEVERAL VIEWS OF THE DRAWINGS

FIG. (FIG) 1 is a block diagram of an example of an implementation of a system for automated access control for rendered output according to an embodiment of the present subject matter;

FIG. (FIG) 2 is a block diagram of an example of an implementation of a core processing module suitable for use in association with a computing device to perform automated access control for rendered output based upon access privilege requirements for content and an access privilege level of at least one of a person, a device, and/or a location associated with a content rendering action according to an embodiment of the present subject matter;

FIG. (FIG) 3 is an illustration of an example of an implementation of a dialog box that may be used to allow a meeting organizer to make selections for automated access control for rendered output as part of a reminder for an upcoming meeting in association with a computing device according to an embodiment of the present subject matter;

FIG. (FIG) 4 is an illustration of an example of an implementation of a graphical user interface (GUI) in a state that represents rendered output that has been selectively redacted based upon the automated access control for rendered output according to an embodiment of the present subject matter;

FIG. (FIG) 5 is a flow chart of an example of an implementation of a process that provides automated access control for rendered output at a computing device according to an embodiment of the present subject matter; and

FIG. (FIG) 6 is a flow chart of an example of an implementation of a process executable by a computing device to provide automated access control for rendered output based upon access privilege requirements for content and an access privilege level of at least one of a person, a device, and/or a location associated with a content rendering action according to an embodiment of the present subject matter.

### DETAILED DESCRIPTION

The examples set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The subject matter described herein provides automated access control for rendered output. Renderable content, such as confidential or sensitive information including documents, images, or other items that may be stored in electronic form and rendered via a display or other output device, may be accessed in a variety of ways by sources other than the content owner. For example, remote access for technical support, remote access copying to a clipboard of a remote device, remote printing, remote displaying, and packaging content for email, text messaging, and instant messaging for transmission represent a few examples of possible access to renderable content. To provide access control for rendered output, a content rendering action associated with renderable content is detected. A determination is made that at least one portion of the renderable content is controlled by an access privilege requirement higher than an access privilege level, (e.g., authority) of a person, a device, or a location associated with the content rendering action. Any portion of the renderable content determined to have the access privilege requirement higher than the access privilege level of the person, the device, or the location associated with the content rendering action is automatically redacted. For multiple rendered output device environments, such as a web conference environment, each rendered output device may be controlled differently to provide different access control for rendered output based upon access privilege levels of persons or locations associated with the respective rendered output device, or based upon an access privilege level associated with each respective device itself.

The automated access control for rendered output described herein may be performed in real time to allow prompt access control for requests for renderable output. For purposes of the present description, real time shall include any time frame of sufficiently short duration as to provide reasonable response time for information processing acceptable to a user of the subject matter described. Additionally, the term “real time” shall include what is commonly termed “near real time”—generally meaning any time frame of sufficiently short duration as to provide reasonable response time for on-demand information processing acceptable to a user of the subject matter described (e.g., within a portion of a second or within a few seconds). These terms, while difficult to precisely define are well understood by those skilled in the art.

By use of the present subject matter, access to content, such as confidential and/or sensitive information, communicated or displayed by a device may be controlled. Access privileges of persons viewing content or the device or location attempting to access the content may be determined, for example, by proximity/location or by identification of the remotely accessing device. Access requirements associated with the content to be communicated or displayed may be determined, such as via an access control list (ACL) for the content. Any portion of the content with an access requirement higher than the lowest access privilege associated with any person, device, or location associated with rendering the content may be automatically redacted.

Content access situations (e.g., content rendering actions) include individual access situations, such as by a technical support person attempting to log into a computer for diagnostic and debugging activities, or by a cleaning person at a corporate location attempting to access an employee's computer after hours. Content access situations also include multiple person access situations, such as a remote web-based or video-based meeting, where multiple people are present at a location remote from a content owner's site. For multiple person access situations, access may be controlled based upon the persons that are present or as a global setting for a given location. Rendering may be configured for a given application, for all applications associated with a device, for main display devices, for remote display devices, and for clipboard copy and printing operations. Automated access controls for rendered output may be configured in advance or at the start of a meeting to allow flexibility based upon changes from planned to actual attendance. Access controls may be configured to automatically start at the beginning of meetings.

Access may also be controlled based upon a target duration of a meeting, such that a vendor meeting in a corporate conference room may be planned for one hour and content redaction may be configured for the planned meeting time or for additional time to allow for overrun of the meeting. Individual locations may have configured servers and/or databases that may be queried to determine persons located at the site. For either individual or multiple person content access situations, access control may be provided to prevent unauthorized viewing, copying, pasting to a clipboard, printing, or other rendering of content that has a higher access requirement than the person(s), device(s), or location(s) associated with the content access situation.

Content rendering applications may be configured to protect content. A content owner may configure the content protection by use of a device configured based upon the present subject matter to allow the content owner to interface with the device to identify content or portions of content to protect. The content may be configured for protection granularly, such that identifiable portions of content may be protected distinctly from other identifiable portions of content. For example, content may be granularly protected based upon item, category, data type, date, or any other suitable approach. Content may be flagged with one or more confidentiality flags, either for one or more portions of the content or for an entire item of content, and the content rendering applications may be configured to process any confidentiality flags associated with content processed by the applications.

As such, content may be marked at any suitable level of granularity for automated access control of rendered output of the content. For example, for a presentation application, each slide or portion of a slide may be separately configured for protection. Additionally, a web log (e.g., blog) application may pass security settings to a rendering device for protection of portions of displayed blog content.

Instant messaging applications may be configured to allow a sender to permit rendering of portions of content or to block rendering of portions of the content based upon access privileges of the receiver. Additionally, email applications may be configured to provide automated access control for rendered output based upon the sender access privileges, receiver access privileges, or access privileges associated with persons on the copy list and blind copy list (e.g., cc and bcc lists) associated with an email communication. In either instant messaging or email communications, the content may be automatically further redacted or blocked if the instant message or email is forwarded by the receiver or if the receiver attempts to forward the content to another party.

Furthermore, if a content receiving application is determined not to support automated access control for rendered output, as described herein, renderable content may be automatically redacted to a lowest access privilege level. The receiving application may also be blocked from rendering any portion of the content in such a situation if appropriate for a given application and item of content. Recording systems may be prohibited from recording content with an access privilege requirement higher than a lowest access privilege level associated with the recording system.

Requests for content may be processed to determine the content access authority of the person, device, or location associated with the request. A content request may include a list of people associated with the content request. The list may, for example, list the people that are anticipated to attend a remote video conference meeting or a name of a technical support agent that is requested to access a device for diagnostic purposes. The content may be redacted based upon the lowest access privilege level of persons in attendance at the meeting. Additionally, for multi-display device situations, content may be redacted based upon the persons in proximity to each display device. Accordingly, security access for each item or portion of an item of content may be determined for each person, device, or location associated with access to renderable content.

Alternatively, radio frequency identifier (RFID) may be used to identify persons in attendance at a remote meeting location or in proximity to a remote display or printing terminal. RFID may also be used in association with employee badges to detect a person approaching or moving away from a content rendering device. Access to content may be granted or redacted in real time based upon the identification of an individual that is located at or that approaches or moves away from a content rendering device. For example, a cleaning person may be determined to be approaching a display or other content rendering device and appropriate measures may be taken to redact content. Furthermore, if an employee with a sufficient authority is determined to have moved away from a content rendering device after viewing content, the content may be redacted based upon, for example, the lowest access privilege level associated with other persons in proximity to the content rendering device. Accordingly, many content protection operations are possible and all are considered within the scope of the present subject matter.

An authorized content control individual, such as a content owner, may be authorized to request a content rendering device or application to adjust the automated redaction of content. For example, as described above, if a technical support person remotely logs into a device that is executing an application upon which diagnostic activities are to be performed, the present subject matter will automatically redact portions of content with an access requirement higher than the technical support person's access privileges. If the technical support person believes that seeing more information, such as a list of names within a database application, may assist with diagnostics, the technical support person or device operated by the technical support person may initiate a request to have an authorized person adjust the automated redaction of content. Within the present example, the authorized person may determine that allowing the technical support person to see the list of given names for diagnostic purposes may be acceptable, but that additional information (e.g., surnames, salaries, addresses, etc.) may not be viewed by the technical support person. In response to making this determination, the authorized user may initiate a user interface action associated with a device that stores or renders the content to request an adjustment of an amount of content associated with a redacted portion of content. In response to receiving the request via the user interface action, a determination of an access privilege level of the person associated with the request may be made to determine whether the person is authorized to issue the request to adjust the redacted amount of content. If the person is authorized to initiate the request, the content redaction may be automatically adjusted. As such, the automated access control for rendered output may be overridden under appropriate circumstances and under the direction of an authorized user of a device that stores or renders the content.

A user may also be provided with user interface functionality that allows the authorized user to rapidly select portions of content for processing as described above. For example, the user may be provided with user interface functionality for highlighting or “right clicking” an area of content displayed on a display device with a mouse, whether the content is presently redacted or not, and to initiate requests to redact or adjust redaction for the selected portions of content. A pop-up menu with keystroke or icon-based input processing may expedite receipt of an indication to redact or adjust the automated redaction from an authorized user. As described above, access privileges associated with the request will be processed prior to changes to adjust automated content redaction.

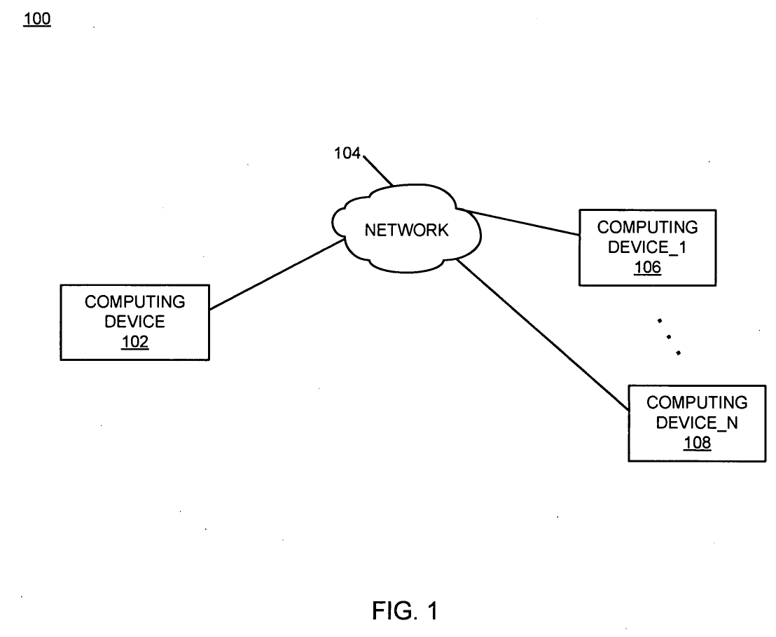

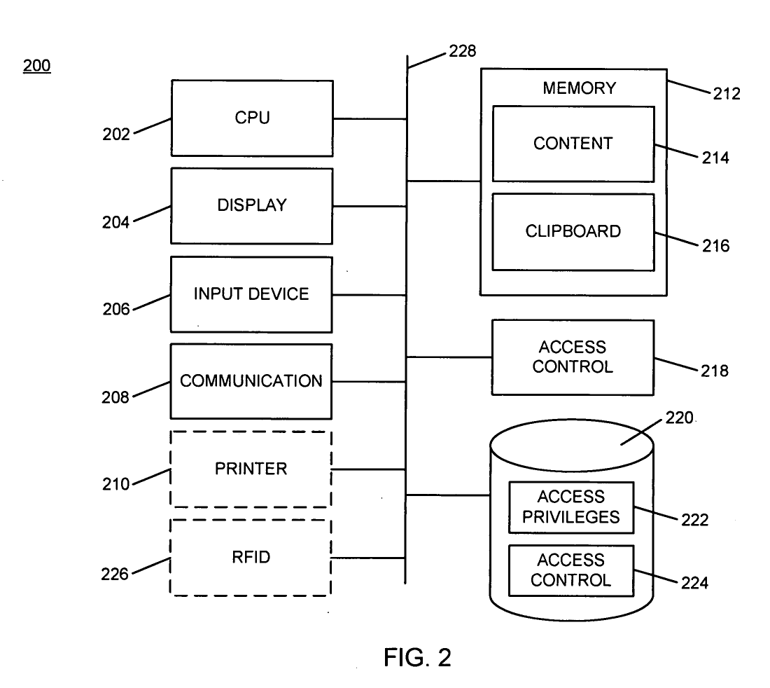

FIG. 1 is a block diagram of an example of an implementation of a system 100 for automated access control for rendered output. Within the system 100, a computing device 102 interconnects via a network 104 to a computing device_1 106 through a computing device_N 108. As will be described in more detail below in association with FIG. 2 through FIG. 6, the computing device 102 provides automated access control for rendered output for content rendered by either the computing device 102 or the computing device_1 106 through the computing device_N 108. For purposes of the present example, it will be assumed that the computing device 102 is associated with an owner of renderable content and that the computing device_1 106 through the computing device_N 108 are remote computing devices associated with a remote location at which the content may be rendered, as described in more detail below.

Additionally, as described above and in more detail below, the automated access control for rendered output may be applied differently for rendered output at each of the computing device_1 106 through the computing device_N 108 for multiple access situations, such as a web conference or a video conferencing. Further, the different rendered output at each of the respective devices may be based upon an access privilege level associated with one or more persons and/or a location associated with each respective device, or may be based upon an access privilege level associated with each respective device itself. Many possibilities exist for multiple access situations and all are considered within the scope of the present subject matter.

It should be noted that the computing device 102 may be a portable computing device, either by a user's ability to move the computing device 102 to different locations or by the computing device 102's association with a portable platform, such as a plane, train, automobile, or other moving vehicle. It should also be noted that the computing device 102 may be any computing device capable of initiating messages for processing by the computing device_1 106 through the computing device_N 108, as described above and in more detail below. For example, the computing device 102 may include devices such as a personal computer (e.g., desktop, laptop, palm, etc.) or a handheld device (e.g., cellular telephone, personal digital assistant (PDA), email device, music recording or playback device, etc.), or any other device capable of processing information as described in more detail below.

The network 104 may include any form of interconnection suitable for the intended purpose, including a private or public network such as an intranet or the Internet, respectively, direct inter-module interconnection, dial-up, wireless, or any other interconnection mechanism capable of interconnecting the devices within the system 100.

FIG. 2 is a block diagram of an example of an implementation of a core processing module 200 suitable for use in association with a computing device, such as the computing device 102, or the computing device_1 106 through the computing device_N 108, to perform automated access control for rendered output based upon access privilege requirements for content and an access privilege level of at least one of a person, a device, and/or a location associated with a content rendering action. For purposes of the present description, the core processing module 200 will be described with respect to operations performed on the computing device 102. It will be assumed that the computing device 102 represents a device that stores renderable content that is subject to access controls and that processes content rendering actions, such as requests for renderable content from any of the computing device_1 106 through the computing device_N 108. It is understood that complementary actions to those described above may be performed by a core processing module 200 associated with any of the computing device_1 106 through the computing device_N 108 to respond to access controls implemented by the core processing module 200 of the computing device 102.

A central processing unit (CPU) 202 provides computer instruction, execution, computation, and other capabilities within the core processing module 200. A display 204 provides visual information to a user of the core processing module 200 and an input device 206 provides input capabilities for the user.

The display 204 may include any display device, such as a cathode ray tube (CRT), liquid crystal display (LCD), light emitting diode (LED), projection, touchscreen, or other display element or panel. The input device 206 may include a computer keyboard, a keypad, a mouse, a pen, a joystick, or any other type of input device by which the user may interact with and respond to information on the display 204. For purposes of the present subject matter, an attempt by a user to display content on the display 204 represents an example of a content rendering action, in response to which the core processing module 200 may operate to provide automated access control for the rendered output to redact or otherwise control access to renderable content.

A communication module 208 provides interconnection capabilities that allow the core processing module 200 to communicate with other modules within the system 100, such as any of the computing device_1 106 through the computing device_N 108 when implemented in association with the computing device 102, to perform activities associated with automated access control for rendered content. The communication module 208 may include any electrical, protocol, and protocol conversion capabilities useable to provide the interconnection capabilities. Though the communication module 208 is illustrated as a component-level module for ease of illustration and description purposes, it should be noted that the communication module 208 may include any hardware, programmed processor(s), and memory used to carry out the functions of the communication module 208 as described above and in more detail below. For example, the communication module 208 may include additional controller circuitry in the form of application specific integrated circuits (ASICs), processors, antennas, and/or discrete integrated circuits and components for performing communication and electrical control activities associated with the communication module 208. Additionally, the communication module 208 may include interrupt-level, stack-level, and application-level modules as appropriate. Furthermore, the communication module 208 may include any memory components used for storage, execution, and data processing for performing processing activities associated with the communication module 208. The communication module 208 may also form a portion of other circuitry described without departure from the scope of the present subject matter.

A printer 210 provides rendered output capabilities for the core processing module 200 to media, such as paper. The core processing module 200 may use the printer 210 to provide rendered output in response to requests for rendered content. As described above, portions of rendered output, or all of the rendered output, may be automatically redacted prior to sending to the printer 210. As such, the present subject matter allows devices that implement the core processing module 200 to control access to content rendered for printing in addition to content that is stored, displayed, or communicated to other devices. For purposes of the present subject matter, an attempt by a user to print content to the printer 210 represents another example of a content rendering action, in response to which the core processing module 200 may operate to provide automated access control for the rendered output to redact or otherwise control access to renderable content.

It should be noted that the printer 210 is illustrated with a dashed-line representation within FIG. 2 to indicate it is an optional component for the core processing module 200. Accordingly, the core processing module 200, in association with the computing device 102 or any of the computing device_1 106 through the computing device_N 108, may operate completely without providing output capabilities via printed media in response to requests for rendered content. However, the core processing module 200, in association with the computing device 102 or any of the computing device_1 106 through the computing device_N 108, may use the printer 210 to provide rendered output in response to requests for rendered content. Further, the printer 210 may be connected via a network, such as the network 104, without departure from the scope of the present subject matter.

A memory 212 includes a content storage area 214 that stores renderable content. The content stored within the content storage area 214 may be stored in redacted or un-redacted format, as suitable for the intended implementation. For example, on the computing device 102 of the present example, the content may be stored without redaction. However, when content is sent to any of the computing device_1 106 through the computing device_N 108, it may be communicated in un-redacted form or in redacted form with appropriate controls, as described in more detail below, to ensure that the content is rendered with redaction based upon configured content access privileges. Many possibilities exist for automated access control for rendered output and all are considered within the scope of the present subject matter.

The memory 212 also includes a clipboard storage area 216. The clipboard storage area 216 stores content copied from an open portion of content when selected by a user of a device that implements the core processing module 200. The user may select and attempt to copy content to the clipboard storage area 216 using devices such as the input device 206. For purposes of the present subject matter, an attempt by a user to copy content, via the input device 206, to the clipboard storage area 216 represents another example of a content rendering action, in response to which the core processing module 200 may operate to provide automated access control for the rendered output to redact or otherwise control access to renderable content.

It is understood that the memory 212 may include any combination of volatile and non-volatile memory suitable for the intended purpose, distributed or localized as appropriate, and may include other memory segments not illustrated within the present example for ease of illustration purposes. For example, the memory 212 may include a code storage area, a code execution area, and a data area without departure from the scope of the present subject matter.

A content access control module (e.g., device) 218 is also illustrated. The content access control module 218 provides the automated access control for rendered output of renderable content. As will be described in more detail below, the content access control module 218 is capable of automatically redacting at least one portion of renderable content determined to have an access privilege requirement higher than an access privilege level of at least one of a person, a device, and/or a location associated with a content rendering action.

A database 220 is associated with the core processing module 200 and provides storage capabilities for information associated with the automated access control for rendered output. The database 220 includes an access privileges storage area 222 and an access control storage area 224 that may be stored in the form of tables or other arrangements accessible by the core processing module 200. The access privileges storage area 222 includes information, such as access privilege information and access processing rules, useable to identify access privileges associated with a person, device, and/or location. The access privileges storage area 222 may also include information, such as rules, that may be associated with rendering of content (e.g., displaying, printing, copying, etc.) in association with the respective person, device and/or location. Many other examples of access privilege information are possible and all are considered within the scope of the present subject matter.

The access control storage area 224 includes information, such as access rights, for items of renderable content. Granularity information may also be associated with items of renderable content to allow each identifiable portion of an item of renderable content to be separately regulated for access for rendering. Many other examples of access control information are possible and all are considered within the scope of the present subject matter.

A radio frequency identifier (RFID) module 226 is illustrated. The RFID module 226 provides detection capabilities for RFID-compatible objects, such as RFID tags that may be associated with employee badges. As will be described in more detail below, the RFID module 226 is capable of automatically detecting persons or objects approaching or leaving a location associated with the RFID module 226 when an RFID tag is associated with the person or object.

It should be noted that the RFID module 226 is also illustrated with a dashed-line representation within FIG. 2 to indicate it is an optional component for the core processing module 200. Accordingly, the core processing module 200, in association with the computing device 102 or any of the computing device_1 106 through the computing device_N 108, may operate completely without providing RFID information in association with requests for rendered content. However, the core processing module 200, in association with the computing device 102 or any of the computing device_1 106 through the computing device_N 108, may use the RFID module 226 to identify location information and proximity information for persons associated with requests for rendered content.

For example, when the computing device 102 represents a device associated with an “owner” of content and the computing device_1 106 is associated with a remote login to the computing device 102, such as for a web meeting or other purpose, the computing device_1 106 may be configured with the RFID module 226. The computing device 102 may then communicate with the computing device_1 106 in association with the remote login activity to request the computing device_1 106 to identify all persons proximate to an output rendering device, such as the display 204 or the printer 210, associated with the computing device 1106. The computing device_1 106 may then utilize RFID functionality associated with the RFID module 226 to identify persons proximate to the respective output device. The computing device_1 106 may then communicate identification information associated with the person(s) proximate to the output device and the computing device 102 may determine appropriate automated access control for rendered output based upon access privilege requirements for content and an access privilege level of at least one of the person, the device, and/or the location associated with a content rendering action.

Though the content access control module 218 and the RFID module 226 are illustrated as component-level modules for ease of illustration and description purposes, it should be noted that the content access control module 218 and the RFID module 226 may include any hardware, programmed processor(s), and memory used to carry out the functions of the content access control module 218 and the RFID module 226 as described above and in more detail below. For example, the content access control module 218 and the RFID module 226 may include additional controller circuitry in the form of application specific integrated circuits (ASICs), processors, antennas, and/or discrete integrated circuits and components for performing communication and electrical control activities associated with the access control module 218 and the RFID module 226, respectively. Additionally, the content access control module 218 and the RFID module 226 may also include interrupt-level, stack-level, and application-level modules as appropriate. Furthermore, the content access control module 218 and the RFID module 226 may include any memory components used for storage, execution, and data processing for performing processing activities associated with the content access control module 218 and the RFID module 226, respectively. The content access control module 218 and the RFID module 226 may also form a portion of other circuitry described without departure from the scope of the present subject matter.

The CPU 202, the display 204, the input device 206, the communication module 208, the printer 210, the memory 212, the content access control module 218, and the database 220 are interconnected via an interconnection 228. The interconnection 228 may include a system bus, a network, or any other interconnection capable of providing the respective components with suitable interconnection for the respective purpose.

While the core processing module 200 is illustrated with and has certain components described, other modules and components may be associated with the core processing module 200 without departure from the scope of the present subject matter. Additionally, it should be noted that, while the core processing module 200 is described as a single device for ease of illustration purposes, the components within the core processing module 200 may be co-located or distributed and interconnected via a network without departure from the scope of the present subject matter. For a distributed arrangement, the display 204 and the input device 206 may be located at a point of sale device, kiosk, or other location, while the CPU 202 and memory 212 may be located at a local or remote server. Further, the RFID module 226 may be located proximate to a rendering location, such as the display 204, while other components may be located further from the rendering location. Many other possible arrangements for components of the core processing module 200 are possible and all are considered within the scope of the present subject matter. It should also be understood that, though the access privileges storage area 222 and the access control storage area 224 are shown within the database 220, they may also be stored within the memory 212 without departure from the scope of the present subject matter. Accordingly, the core processing module 200 may take many forms and may be associated with many platforms.

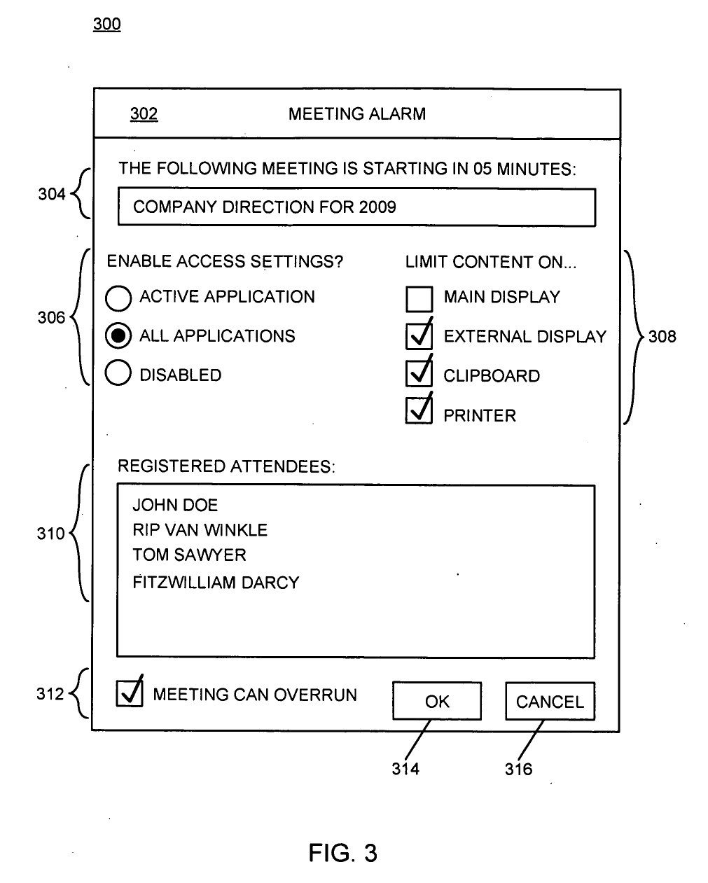

FIG. 3 is an illustration of an example of an implementation of a dialog box 300 that may be used to allow a meeting organizer to make selections for automated access control for rendered output as part of a reminder for an upcoming meeting in association with a device, such as the computing device 102. Within the dialog box 300, a title area 302 indicates that the dialog box 300 is associated with a meeting alarm. A meeting designation region 304 indicates the meeting title and time remaining until the meeting starts. An application selection region 306 allows the meeting organizer to select whether automated access controls are enabled, and whether automated access controls are to apply to all applications or to active applications. It is understood that such a set of selection options may apply to applications associated with any computing devices associated with a meeting, such as local and remote computing devices.

An output selection region 308 allows the meeting organizer to select output options for which to apply automated access controls, such as on a main display, an external display device (e.g., remote display), a clipboard (e.g., local or remote), and a printer (e.g., local or remote). An attendees section 310 allows the meeting organizer to identify the invited participants for the meeting. An overrun selection region 312 allows the meeting organizer to select whether the meeting may overrun, where, in such a case the automated access controls may persist beyond the designated stop time for the meeting. An “OK” button 314 and a “Cancel” button 316 allow the meeting organizer to indicate acceptance or cancellation of selected options, respectively. When the meeting organizer selects acceptance of selected options for a given meeting, automated access controls for rendered content are implemented on systems and computing devices associated with the meeting as described above and in more detail below.

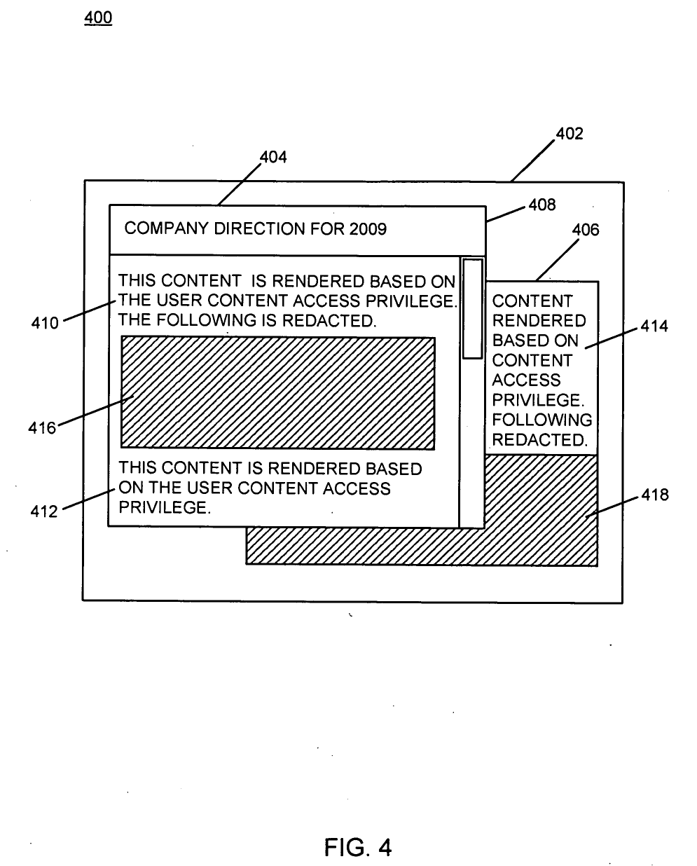

FIG. 4 is an illustration of an example of an implementation of a graphical user interface (GUI) 400 in a state that represents rendered output that has been selectively redacted based upon the automated access control for rendered output of the present subject matter. It is understood that the example GUI 400 is suitable for display on a display device, such as the display 204 of a computing device such as the computing device 102 or any of the computing device_1 106 through the computing device_N 108. As such, a display screen 402 associated with the respective display 204 is illustrated rendering the GUI 400. The example of FIG. 4 represents one possible view of rendered output that has been selectively redacted. It is understood that for a multiple rendered output device environment, such as a web conference environment, each rendered output device may be controlled differently to provide different access control for rendered output based upon access privilege levels of persons or locations associated with the respective rendered output device, or based upon an access privilege level associated with each respective device. The GUI 400 includes a first user-interface window 404 and a second user-interface window 406. The first user-interface window 404 is understood to be in “focus” within the GUI 400. As such, a portion of the second user-interface window 406 is not visible. However, as can be seen from FIG. 4, a portion of renderable content associated with each of the first user-interface window 404 and the second user-interface window 406 has been redacted based upon the automated access control for rendered output associated with the present subject matter.

The first user-interface window 404 includes a title bar 408 that indicates the first user-interface window 404 is associated with a company direction for the year 2009. For purposes of the present example, it is assumed that the second user-interface window 406 is associated with information other than the company direction information. Regarding renderable content associated with each of the first user-interface window 404 and the second user-interface window 406, it is understood that renderable content for display in each of the respective windows may be considered private or confidential for the company that maintains this information. As such, based upon the present subject matter, the company may assign access privilege requirements to renderable content associated with each of the respective windows. The access privilege requirements may be granular and assigned on an item-by-item basis. Further, the company may assign access privilege levels to the persons, devices, and/or locations associated with potential rendering of the renderable content.

For purposes of the present example, it is assumed that each paragraph of renderable content is assigned a different access priority requirement and that a person viewing the rendered output has an access privilege level lower than the highest access privilege requirement associated with the respective portions of renderable content. As such, a portion 410 and a portion 412 within the first user-interface window 404 and a portion 414 within the second user-interface window 406 are displayed based upon an access privilege level of a person viewing or in proximity to the GUI 400 being equal to or higher than the access privilege requirement for the content. In contrast, a portion 416 within the first user-interface window 404 and a portion 418 within the second user-interface window 406 are redacted based upon an access privilege level of a person viewing or in proximity to the GUI 400 being lower than the access privilege requirement for the content.

Accordingly, as can be seen from FIG. 4 and the description above, rendered output has been selectively redacted based upon the automated access control for rendered output of the present subject matter. Further, the automated access control for rendered output has been applied in a granular fashion to allow the selective redaction of individual items of content.

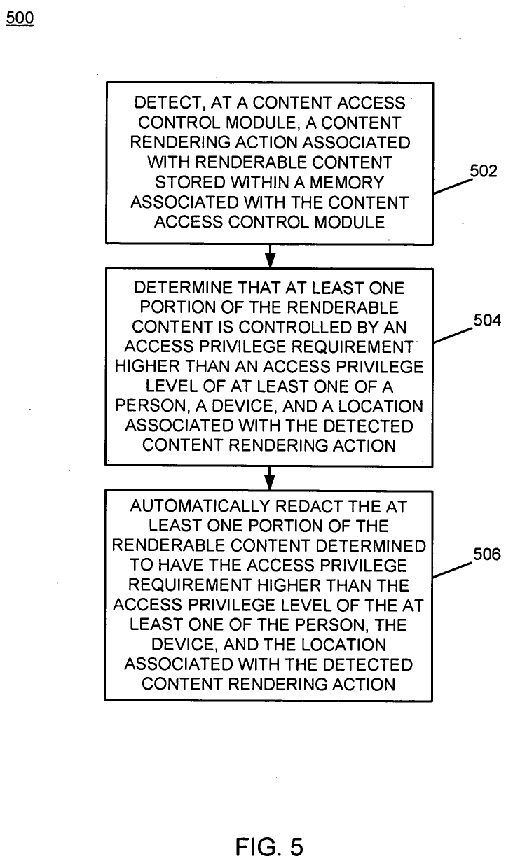

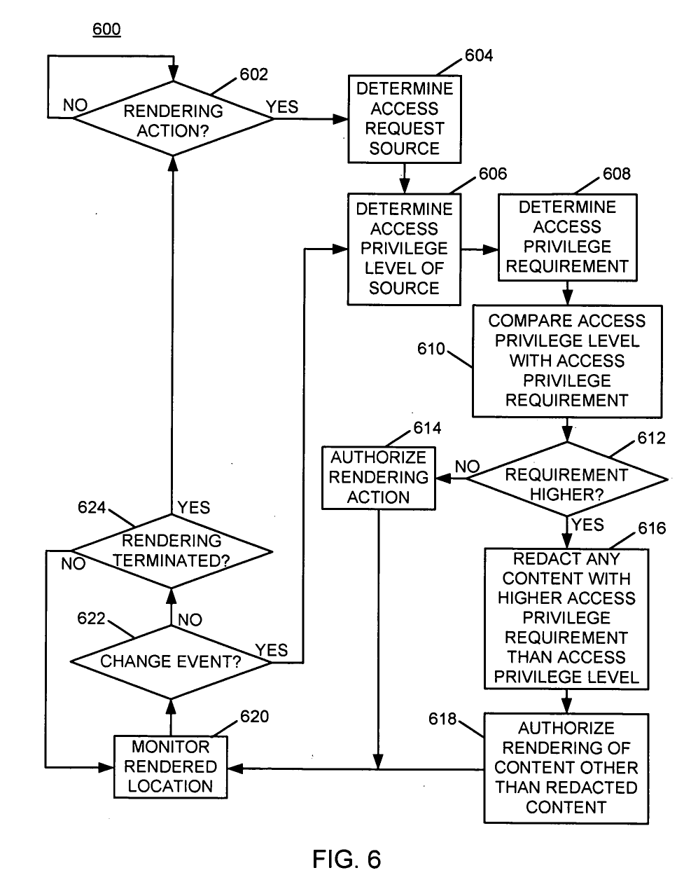

FIGS. 5 through 6 below describe example processes that may be executed by devices, such as the computing device 102, to perform the automated access control for rendered output associated with the present subject matter. Many other variations on the examples processes are possible and all are considered within the scope of the present subject matter. The example processes may be performed by modules, such as the content access control module 218 and/or executed by the CPU 202, associated with computing devices. It should be noted that time out procedures and other error control procedures are not illustrated within the example processes described below for ease of illustration purposes. However, it is understood that all such procedures are considered to be within the scope of the present subject matter.

FIG. 5 is a flow chart of an example of an implementation of a process 500 that provides automated access control for rendered output at a device, such as the computing device 102 and/or the content access control module 218. At block 502, the process 500 detects, at a content access control module, a content rendering action associated with renderable content stored within a memory associated with the content access control module. At block 504, the process 500 determines that at least one portion of the renderable content is controlled by an access privilege requirement higher than an access privilege level of at least one of a person, a device, and a location associated with the detected content rendering action. At block 506, the process 500 automatically redacts the at least one portion of the renderable content determined to have the access privilege requirement higher than the access privilege level of the at least one of the person, the device, and the location associated with the detected content rendering action.

FIG. 6 is a flow chart of an example of an implementation of a process 600 executable by a device, such as the computing device 102 or any of the computing device_1 106 through the computing device_N 108, to provide automated access control for rendered output based upon access privilege requirements for content and an access privilege level of at least one of a person, a device, and/or a location associated with a content rendering action. For ease of illustration purposes, the process 600 will be described from the perspective of the computing device 102. However, it is understood that the process 600 may be modified in certain behavioral aspects to operate on any of the computing device_1 106 through the computing device_N 108 without departure from the scope of the present subject matter.

At decision point 602, the process 600 waits to detect a content rendering action. As described above, detection of a content rendering action may include detection of a remote access associated with the renderable content via a remote login from a device, such as the computing device_1 106, to a device, such as the computing device 102, that stores the renderable content. Detection of the content rendering action may also include detection of a remote access associated with the renderable content via a remote login to a device that renders the renderable content. Many other examples exist for detection of a content rendering action. For example, detection of an attempt to copy the renderable content to a clipboard memory location of a remote computing device in association with the remote login to the device that at least one of stores and renders the renderable content, detection of an attempt to print the renderable content to at least one of a printer and a file associated with the remote computing device in association with the remote login to the device that at least one of stores and renders the renderable content, and detection of an attempt to display the renderable content on a display device associated with the remote computing device in association with the remote login to the device that at least one of stores and renders the renderable content are additional examples of possible content rendering actions that may be detected. Additionally, detection of an attempt to package the renderable content for transmission via at least one of email, text messaging, and instant messaging, and detection of an attempt to render the renderable content on a content rendering device associated with a computing device that does not support automated redaction of the renderable content are also examples of possible content rendering actions that may be detected. These example content rendering actions may occur at either the computing device 102 or the computing device_1 106 within the present example, as appropriate for the given implementation. It is further understood that other examples of content rendering actions are possible and all are considered within the scope of the present subject matter.

When a determination is made that a content rendering action has occurred, the process 600 determines an access request source at block 604. The access request source may be a person, a device, and/or a location associated with the detected content rendering action. As such, the access request source may be a person logging into the computing device 102 while situated at the device. Alternatively, the access request source may be a person remotely logging into the computing device 102 from the computing device_1 106, such as a technical support person, an invitee for a web meeting, or a colleague. Additionally, the access request source may be the computing device_1 106 during a remote login to the computing device 102. Further, the access request source may be a location associated with the computing device_1 106 during a remote login to the computing device 102 for a web meeting or other purpose. The location information may be stored, for example, within the access privileges storage area 222 of the database 220 on the respective device and may be communicated in association with the remote login for use during automated access control activities for rendered output.

At block 606, the process 600 determines an access privilege level of the source of the access request. The process 600 may determine the access privilege level via the access privileges storage area 222 of the device, such as the computing device 102, that stores (e.g., owns) the renderable content. Additionally, the process 600 may query a local or remote database for an access control list (ACL) that defines the access privilege level for the at least one of the person, the device, and/or the location associated with the content rendering action and determine the access privilege level of the source of the access request based upon the ACL. Further, the process 600 may access a distribution list associated with the content rendering action identifying intended recipients of the renderable content and determine the access privilege level of the source of the access request based upon the distribution list. The process 600 may also analyze a list of participants associated with a meeting and determine the access privilege level of the source of the access request based upon the list of participants. Many other examples of processing to determine the access privilege level of the source of the access request are possible and all are considered within the scope of the present subject matter.

At block 608, the process 600 determines an access privilege requirement for the content associated with the access request. As described above, the access privilege requirement may be granular and identified for each item of content having an associated access privilege requirement assigned. The process 600 may determine the access privilege requirement for the content associated with the access request via the access control storage area 224 of the database 220 of the device, such as the computing device 102, that stores (e.g., owns) the renderable content. Additionally, the process 600 may query a database for access control information that defines the access privilege requirements of any regulated portions of the renderable content. The process 600 may also retrieve a confidentiality flag and any associated metadata associated with the access privilege requirement of any regulated portions of the renderable content. Based upon these examples, the process 600 then determines the access privilege requirement for the content associated with the access request by, for example, analyzing access control information, a confidentiality flag, and/or metadata associated with the renderable content. The process 600 may further identify the access privilege requirement of at least one portion of the renderable content based upon the access control information, the confidentiality flag, and/or the metadata.

At block 610, the process 600 compares the access privilege level of the source of the access request with the access privilege requirement of the content. At decision point 612, the process 600 makes a determination as to whether any access privilege requirement for the content is higher than any access privilege level of the person, device, and/or location associated with the access request. When a determination is made that there is no access privilege requirement for the content that is higher than any access privilege level of the person, the device, and/or the location associated with the access request, the process 600 authorizes the content rendering action at block 614.

When a determination is made that there is at least one access privilege requirement for at least one portion of the renderable content that is higher than an access privilege level of at least one of the person, the device, and/or the location associated with the access request, the process 600 automatically redacts any content with a higher access privilege requirement than the access privilege level associated with the access request at block 616. Automatically redacting a portion of the renderable content may include removing the portion of the renderable content from a renderable version of the renderable content, and may include either blanking or darkening the portion of the renderable content within the renderable version of the renderable content. Automatically redacting a portion of the renderable content may also include preventing a remote access to the portion of the renderable content via a remote login to a device that stores and/or renders the renderable content. Additionally, automatically redacting a portion of the renderable content may include preventing an attempt to copy the portion of the renderable content to a clipboard memory location of a remote computing device in association with the remote login to the device that at least one of stores and renders the renderable content, preventing an attempt to print the portion of the renderable content to at least one of a printer and a file associated with the remote computing device in association with the remote login to the device that stores and/or renders the renderable content. Further, automatically redacting a portion of the renderable content may include preventing an attempt to display the at least one portion of the renderable content on a display device associated with the remote computing device in association with the remote login to the device that at least one of stores and renders the renderable content, preventing an attempt to package the at least one portion of the renderable content for transmission via at least one of email, text messaging, and instant messaging, and preventing an attempt to render the renderable content on a content rendering device associated with a computing device that does not support automated redaction of the renderable content. Many other examples of automated redaction of renderable content are possible and all are considered within the scope of the present subject matter.

At block 618, the process 600 authorizes rendering of content other than the redacted content. Authorizing rendering of the content other than the redacted content may include sending the content other than the redacted content, including any associated formatting, from the computing device 102 to the computing device_1 106 within the present example. Alternatively, if appropriate for a given implementation, authorizing rendering of the content other than the redacted content may include initiating messaging from the computing device 102 to the computing device_1 106 to instruct the content access control module 218 of the computing device_1 106 to perform the redaction. Many other examples are possible for performing an action to authorize rendering of the content other than the redacted content. Additionally, many other example are possible for providing automated access control for rendered output based upon access privilege requirements for content and an access privilege level of at least one of a person, a device, and/or a location associated with a content rendering action. Accordingly, any such possibilities are considered within the scope of the present subject matter.

Upon authorization of the rendered content other than the redacted content at block 618 or upon authorization of the rendering action at block 614, the process 600 begins monitoring the rendered location at block 620. Monitoring the rendered location may include monitoring the rendered location via at least one radio frequency identifier (RFID) monitoring device. For example, the computing device 102 may initiate messaging with the computing device_1 106 to cause the content access control module 218 of the computing device_1 106 to respond with RFID information via the RFID module 226 of the computing device_1 106 regarding persons proximate to the computing device_1 106. Additionally, the computing device 102 may initiate messaging with the computing device_1 106 to cause the content access control module 218 of the computing device_1 106 to respond with access privileges retrieved from the access privileges storage location 222 of the computing device_1 106 of persons detected either approaching or departing from a content rendering device, such as the display 204. Alternatively, the computing device may monitor the local display 204 for persons approaching or departing from a location associated with the display 204. Monitoring the rendered location may also include monitoring for additional login requests from users associated with a device proximate to the rendered location. Many other examples of monitoring a rendered content location exist and all are considered within the scope of the present subject matter.

At decision point 622, the process 600 makes a determination as to whether a change event has occurred in association with the rendered content. The change event may include detecting a person approaching the rendered location via the RFID monitoring device. The determination of the change event may also include determining that an additional (e.g., second) portion of the resulting portion of the renderable content other than the redacted content is controlled by an access privilege requirement higher than an access privilege level of a person approaching the rendered location.

When the process 600 detects that a change event has occurred, such as a person approaching or leaving the rendered location, the process 600 returns to block 606 to continue processing as described above to determine an access privilege level of the approaching person or of any remaining person(s) and re-processes authorization levels and requirements to determine an appropriate redaction level for the renderable content. For example, upon a determination that a person is approaching, the process 600 may automatically redact an additional portion of the resulting portion of the renderable content determined to have an access privilege requirement higher than the access privilege level of the person approaching the rendered location. Conversely, upon a determination that a person has departed a location, the process 600 may automatically un-redact a portion of the resulting portion of the renderable content determined to have the access privilege requirement lower than the access privilege level of any person(s) remaining at the rendered location.

The person approaching the rendered location may, for example, be a person that was invited to a meeting that was not on the original invitation list for the meeting or a cleaning person approaching a display, such as the display 204, where the content is rendered. A person departing from the rendered location may be a person leaving a meeting early to attend another meeting. The process 600 may determine an identity of the person approaching or leaving the rendered location based upon the RFID detection and may use the determined identity to determine the access privilege level of the person approaching or leaving the location via access to a local or remote access privilege storage area, such as the access privileges storage area 222 associated with either the computing device 102 or the computing device_1 106, as appropriate for the given implementation. The process 600 may also determine an identity of any person(s) remaining at the rendered location based upon RFID detection via similar processing.

It should be understood that the change event detected at decision point 622 may also include a request received from an administrator or owner of the content, such as a meeting organizer, to adjust an amount of renderable content associated with a redacted portion of the renderable content. As such, when the process 600 returns to block 606 to continue processing as described above, the process 600 may determine that an access privilege level of a person associated with the request to adjust the amount of renderable content associated with a redacted portion of the renderable content authorizes the person to issue the request to adjust the amount of renderable content associated with the redacted portion of the renderable content. Upon such a determination, the process 600 may automatically adjust the amount of renderable content associated with the redacted portion of the renderable content in response to determining that the person is authorized to issue the request.

Upon completion of any processing associated with any determined change event at decision point 622 and any subsequent processing, as described above, or upon determining that no change event has occurred, the process 600 makes a determination at decision point 624 as to whether the rendering action has been terminated. Termination of the rendering action may include completion of a meeting, a rendering device being powered down, or any other suitable termination rendering action. When a determination is made that the content rendering has not been terminated, the process 600 returns to block 620 to continue monitoring the rendered location and determining whether any change events have occurred, as described above. When a determination is made that the content rendering has been terminated, the process 600 returns to decision point 602 to await another content rendering action.

As described above in association with FIGS. 1 through 6, the example systems and processes provide automated access control for rendered output. Many other variations and additional activities associated with automated access control for rendered output are possible and all are considered within the scope of the present subject matter.

Those skilled in the art will recognize, upon consideration of the above teachings, that certain of the above examples are based upon use of a programmed processor such as CPU 202. However, the invention is not limited to such exemplary embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

As will be appreciated by one skilled in the art, aspects of the present invention may be embodied as a method, apparatus, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention has been described with reference to flowchart illustrations and/or block diagrams of methods, apparatus (systems) and computer program products according to example embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable storage medium that can direct a computer or other programmable data processing apparatus to function in a particular manner, such that the instructions stored in the computer-readable storage medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible example implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
detecting, at a content access control module, a content rendering action associated with renderable content stored within a memory associated with the content access control module;
determining that at least one portion of the renderable content is controlled by an access privilege requirement higher than an access privilege level of at least one of a person, a device, and a location associated with the detected content rendering action; and
automatically redacting the at least one portion of the renderable content determined to have the access privilege requirement higher than the access privilege level of the at least one of the person, the device, and the location associated with the detected content rendering action.

2. The method of claim 1,
where detecting, at the content access control module, the content rendering action associated with the renderable content further comprises detecting a remote access associated with the renderable content via a remote login; and
where automatically redacting the at least one portion of the renderable content determined to have the access privilege requirement higher than the access privilege level of the at least one of the person, the device, and the location associated with the detected content rendering action further comprises preventing the remote access to the at least one portion of the renderable content via the remote login to the device that at least one of stores and renders the renderable content.

3. The method of claim 1, further comprising at least one of:
querying a database for an access control list (ACL) that defines the access privilege level for the at least one of the person, the device, and the location associated with the detected content rendering action;
accessing a distribution list associated with the detected content rendering action identifying intended recipients of the renderable content; and
analyzing a list of participants associated with a meeting; and
where determining that the at least one portion of the renderable content is controlled by the access privilege requirement higher than the access privilege level of the at least one of the person, the device, and the location associated with the detected content rendering action further comprises determining the access privilege level of the at least one of the person, the device, and the location based upon the at least one of the ACL, the distribution list, and the list of participants.

4. The method of claim 1, further comprising:
querying a database for access control information that defines the access privilege requirements of the at least one portion of the renderable content; and
where determining that the at least one portion of the renderable content is controlled by the access privilege requirement higher than the access privilege level of the at least one of the person, the device, and the location associated with the detected content rendering action further comprises determining the access privilege requirement of the at least one portion of the renderable content by:
analyzing the access control information; and
identifying the access privilege requirement of the at least one portion of the renderable content based upon the access control information.

5. The method of claim 1, where automatically redacting the at least one portion of the renderable content determined to have the access privilege requirement higher than the access privilege level of the at least one of the person, the device, and the location associated with the detected content rendering action further comprises at least one of:
removing the at least one portion of the renderable content from a renderable version of the renderable content;
blanking the at least one portion of the renderable content within the renderable version of the renderable content; and
darkening the at least one portion of the renderable content within the renderable version of the renderable content.

6. The method of claim 1, further comprising:
receiving a request to adjust an amount of renderable content associated with the redacted at least one portion of the renderable content;
determining that an access privilege level of a person associated with the request to adjust the amount of renderable content associated with the redacted at least one portion of the renderable content authorizes the person to issue the request to adjust the amount of renderable content associated with the redacted at least one portion of the renderable content; and
automatically adjusting the amount of renderable content associated with the redacted at least one portion of the renderable content in response to determining that the person is authorized to issue the request.

7. The method of claim 1, further comprising:
monitoring a rendered location associated with a display of a resulting portion of the renderable content other than the redacted at least one portion of the renderable content via a radio frequency identifier (RFID) monitoring device;
detecting a person approaching the rendered location via the RFID monitoring device;
determining an identity of the person approaching the rendered location based upon the RFID detection of the person approaching the rendered location;
determining that a second at least one portion of the resulting portion of the renderable content other than the redacted at least one portion of the renderable content is controlled by an access privilege requirement higher than an access privilege level of the person approaching the rendered location based upon the determined identity; and
automatically redacting the second at least one portion of the resulting portion of the renderable content determined to have the access privilege requirement higher than the access privilege level of the person approaching the rendered location.

8. An apparatus, comprising:
a memory that stores renderable content; and
a content access control module, configured to:
detect a content rendering action associated with the renderable content;
retrieve the renderable content from the memory;
determine that at least one portion of the renderable content is controlled by an access privilege requirement higher than an access privilege level of at least one of a person, a device, and a location associated with the detected content rendering action; and
automatically redact the at least one portion of the renderable content determined to have the access privilege requirement higher than the access privilege level of the at least one of the person, the device, and the location associated with the detected content rendering action.

9. The apparatus of claim 8:
where, in being configured to detect the content rendering action associated with the renderable content, the content access control module is further configured to detect a remote access associated with the renderable content via a remote login; and
where, in being configured to automatically redact the at least one portion of the renderable content determined to have the access privilege requirement higher than the access privilege level of the at least one of the person, the device, and the location associated with the detected content rendering action, the content access control module is further configured to prevent the remote access to the at least one portion of the renderable content via the remote login.

10. The apparatus of claim 8, further comprising:
a database; and
a memory; and
where the content access control module is further configured to at least one of:
query the database for an access control list (ACL) that defines the access privilege level for the at least one of the person, the device, and the location associated with the detected content rendering action;
access a distribution list within the memory associated with the detected content rendering action identifying intended recipients of the renderable content; and
analyze a list of participants within the memory associated with a meeting; and
where, in being configured to determine that the at least one portion of the renderable content is controlled by the access privilege requirement higher than the access privilege level of the at least one of the person, the device, and the location associated with the detected content rendering action, the content access control module is further configured to determine the access privilege level of the at least one of the person, the device, and the location based upon the at least one of the ACL, the distribution list, and the list of participants.

11. The apparatus of claim 8, further comprising:
a database; and
where the content access control module is further programmed to:
query the database for access control information that defines the access privilege requirements of the at least one portion of the renderable content; and
where, in being configured to determine that the at least one portion of the renderable content is controlled by the access privilege requirement higher than the access privilege level of the at least one of the person, the device, and the location associated with the detected content rendering action, the content control access module is further configured to:
analyze the access control information; and
identify the access privilege requirement of the at least one portion of the renderable content based upon the access control information.

12. The apparatus of claim 8, where the content control access module is further configured to:
receive a request to adjust an amount of renderable content associated with the redacted at least one portion of the renderable content;
determine that an access privilege level of a person associated with the request to adjust the amount of renderable content associated with the redacted at least one portion of the renderable content authorizes the person to issue the request to adjust the amount of renderable content associated with the redacted at least one portion of the renderable content; and
automatically adjust the amount of renderable content associated with the redacted at least one portion of the renderable content in response to determining that the person is authorized to issue the request.

13. The apparatus of claim 8, where the content control access module is further configured to:
monitor a rendered location associated with a display of a resulting portion of the renderable content other than the redacted at least one portion of the renderable content via a radio frequency identifier (RFID) monitoring device;
detect a person approaching the rendered location via the RFID monitoring device;
determine an identity of the person approaching the rendered location based upon the RFID detection of the person approaching the rendered location;
determine that a second at least one portion of the resulting portion of the renderable content other than the redacted at least one portion of the renderable content is controlled by an access privilege requirement higher than an access privilege level of the person approaching the rendered location based upon the determined identity; and
automatically redact the second at least one portion of the resulting portion of the renderable content determined to have the access privilege requirement higher than the access privilege level of the person approaching the rendered location.

14. A computer program product comprising a computer readable storage medium having computer readable program code embodied therewith, the computer readable program code comprising:
computer readable program code configured to detect a content rendering action associated with the renderable content;
computer readable program code configured to determine that at least one portion of the renderable content is controlled by an access privilege requirement higher than an access privilege level of at least one of a person, a device, and a location associated with the content rendering action; and
computer readable program code configured to automatically redact the at least one portion of the renderable content determined to have the access privilege requirement higher than the access privilege level of the at least one of the person, the device, and the location associated with the content rendering action.

15. The computer program product of claim 14:
where the computer readable program code configured to detect a content rendering action associated with the renderable content comprises computer readable program code configured to detect a remote access associated with the renderable content via a remote login; and
where, computer readable program code configured to automatically redact the at least one portion of the renderable content determined to have the access privilege requirement higher than the access privilege level of the at least one of the person, the device, and the location associated with the content rendering action comprises computer readable program code configured to prevent the remote access to the at least one portion of the renderable content via the remote login.

16. The computer program product of claim 14, further comprising at least one of:
computer readable program code configured to query the database for an access control list (ACL) that defines the access privilege level for the at least one of the person, the device, and the location associated with the content rendering action;
computer readable program code configured to access a distribution list within the memory associated with the content rendering action identifying intended recipients of the renderable content; and
computer readable program code configured to analyze a list of participants within the memory associated with a meeting; and
where, computer readable program code configured to determine that at least one portion of the renderable content is controlled by an access privilege requirement higher than an access privilege level of at least one of a person, a device, and a location associated with the content rendering action comprises computer readable program code configured to determine the access privilege level of the at least one of the person, the device, and the location based upon the at least one of the ACL, the distribution list, and the list of participants.

17. The computer program product of claim 14, further comprising:
computer readable program code configured to query the database for access control information that defines the access privilege requirements of the at least one portion of the renderable content; and
where, computer readable program code configured to determine that at least one portion of the renderable content is controlled by an access privilege requirement higher than an access privilege level of at least one of a person, a device, and a location associated with the content rendering action comprises:
computer readable program code configured to analyze the access control information; and
computer readable program code configured to identify the access privilege requirement of the at least one portion of the renderable content based upon the access control information.

18. The computer program product of claim 14, where, computer readable program code configured to automatically redact the at least one portion of the renderable content determined to have the access privilege requirement higher than the access privilege level of the at least one of the person, the device, and the location associated with the content rendering action comprises at least one of:
computer readable program code configured to remove the at least one portion of the renderable content from a renderable version of the renderable content;
computer readable program code configured to blank the at least one portion of the renderable content within the renderable version of the renderable content; and
computer readable program code configured to darken the at least one portion of the renderable content within the renderable version of the renderable content.

19. The computer program product of claim 14, further comprising:
computer readable program code configured to receive a request to adjust an amount of renderable content associated with the redacted at least one portion of the renderable content;
computer readable program code configured to determine that an access privilege level of a person associated with the request to adjust the amount of renderable content associated with the redacted at least one portion of the renderable content authorizes the person to issue the request to adjust the amount of renderable content associated with the redacted at least one portion of the renderable content; and
computer readable program code configured to automatically adjust the amount of renderable content associated with the redacted at least one portion of the renderable content in response to determining that the person is authorized to issue the request.

20. The computer program product of claim 14, further comprising:
computer readable program code configured to monitor a rendered location associated with a display of a resulting portion of the renderable content other than the redacted at least one portion of the renderable content via a radio frequency identifier (RFID) monitoring device;
computer readable program code configured to detect a person approaching the rendered location via the RFID monitoring device;
computer readable program code configured to determine an identity of the person approaching the rendered location based upon the RFID detection of the person approaching the rendered location;
computer readable program code configured to determine that a second at least one portion of the resulting portion of the renderable content other than the redacted at least one portion of the renderable content is controlled by an access privilege requirement higher than an access privilege level of the person approaching the rendered location based upon the determined identity; and
computer readable program code configured to automatically redact the second at least one portion of the resulting portion of the renderable content determined to have the access privilege requirement higher than the access privilege level of the person approaching the rendered location.
